(19) United States
(12) Patent Application Publication
(10) Pub. No.: US 2011/0147357 A1
(43) Pub. Date: Jun. 23, 2011

(54) ELECTRIC HEATING APPARATUS

(75) Inventors: Tobias Bokelmann, Puchheim (DE); Denise Philipp, Mammendorf (DE)

(73) Assignee: W.E.T. AUTOMOTIVE SYSTEMS AG

(21) Appl. No.: 12/963,030

(22) Filed: Dec. 8, 2010

(30) Foreign Application Priority Data
Dec. 21, 2009 (DE) 10 2009 059 995.9

(51) Int. Cl. B60L 1/02; H05B 3/02

(52) U.S. Cl. 219/202; 219/546

(57) ABSTRACT

The present invention relates to an electric heating apparatus having at least one electric heating resistor and at least one flat heating resistor carrier. It is provided that the heating resistor carrier consists of at least two carrier segments.

### CLAIM OF PRIORITY

The present application claims the benefit of the priority of the filing date of the German Application DE 10 2009 059 995.9 filed on Dec. 21, 2009, which is herein incorporated by reference for all purposes.

### BACKGROUND OF THE INVENTION

A subject matter according to the present invention is an electric heating apparatus according to the preamble of claim 1. It may be used, for example, in heating of seat surfaces or arm rests, in particular in vehicles.

### BACKGROUND INFORMATION

Flexible heating elements, for example, having square textile backings, are known (for example, from DE 8115038). For heating nonrectangular contours, it is also known that the backings may be cut to size, to allow, for example, adaptation to steering wheels or other surfaces (for example, DE 2922620). However, this involves a great deal of waste. To prevent this, a backing could be produced in the desired contour in a precise and targeted manner, for example, by knitting, also working some heating conductors into the backing. However, this method is expensive and the resulting textiles are not suitable for all application cases because of their high elasticity.

Many applications therefore require alternative or improved options, which are advantageous in particular with regard to their production costs and the possibility of selecting alternative materials.

### SUBJECT MATTER OF THE INVENTION

Against this background, a technical concept having the features of claim 1 is proposed. Additional advantageous embodiments can also be derived from the additional claims and the following description.

### FIGURES

Details of the invention are explained below. These descriptions should make the invention understandable, but they serve only as examples. One or more of the features that are described may of course also be omitted, modified or supplemented within the framework of the invention defined by the independent claims. The features of different embodiments may of course be also combined with one another. It is crucial that the concept of the invention is essentially implemented. If a feature is at least partially to be satisfied, this includes the fact that this feature is also completely satisfied or essentially completely satisfied. “Essentially” here means in particular that the implementation allows the desired benefit to be achieved to a recognizable extent. This may mean in particular that a corresponding feature is satisfied at least 50%, 90%, 95% or 99%. If a minimum amount is indicated, then it is of course also possible to use more than this minimum amount. If the number of a component is given as being at least one, then this also includes in particular embodiments having two, three or some other multiple number of components. What is described for an object may also be applied to the predominant portion or the totality of all other objects of the same type. Unless otherwise indicated, intervals also include their boundary points.

Reference is made below to:

FIG. 1 shows vehicle 1 having a seat as a heated object 2 and a heating apparatus 31 in a partial longitudinal section;

FIG. 2 shows a top view of an electric heating apparatus 31 from FIG. 1.

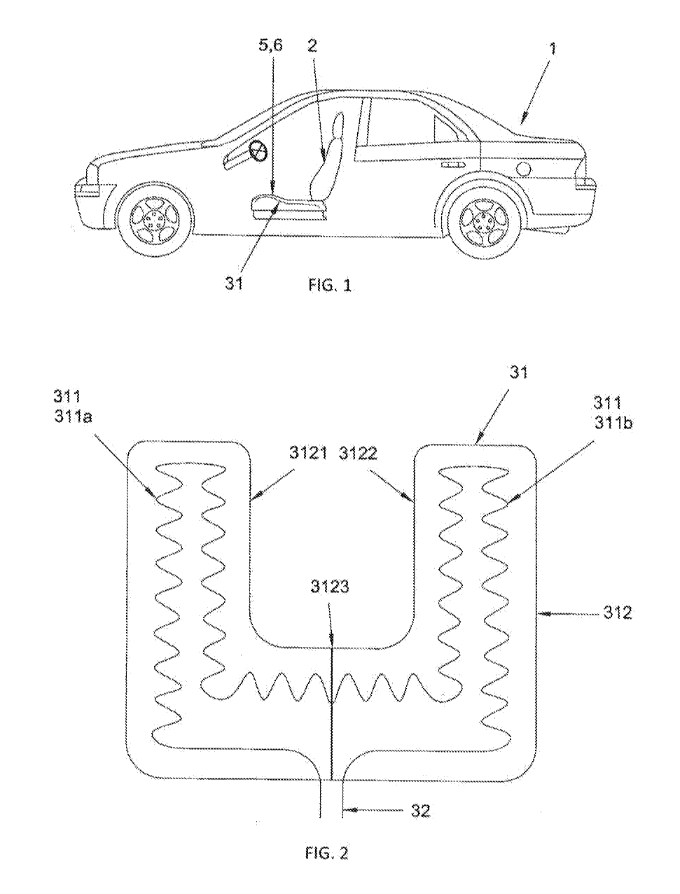

### DESCRIPTION OF THE INVENTION

The invention is suitable in particular for use in vehicles. This refers in particular to all land vehicles, watercraft or aircraft, for example, an airplane, a rail vehicle, a boat or a motor vehicle.

The present invention is also suitable for use with all objects whose surface is to be kept at least partially at a certain temperature level or within a desired temperature interval. The term “heated object” therefore refers in particular to all the components with which a user of a vehicle 1 in a passenger compartment may come in contact, for example, in the case of a motor vehicle, a steering unit, a dashboard, an arm rest, a door panel, a seat rest, a warming blanket, a headliner, a cushion 5, an upholstery covering 6 or a seat.

Expediently at least one vehicle 1 has at least one heated object 2, for example, a seat. This allows thermal regulation and climate control for a passenger even during long trips.

Expediently at least one heated object 2 has at least one cushion 5, for example, a block of polyurethane foam.

Expediently at least one heated object 2 has at least one upholstery covering 6. This refers to any type of surface covering the cushion, for example, a leather or textile covering or an outer membrane of a cushioning foam.

Expediently at least one thermal regulation unit 30 has at least one heating apparatus 31, for example, a flat flexible heating element, preferably at least partially made of textile material.

Preferably at least one heating apparatus 31 is arranged at least partially close to a surface to be heated of the object 2 that is to be climate controlled, for example, between a cushion 5 and a surface to be climate controlled, preferably between a seat foam cushion 5 and a seat covering, for example, beneath a covering 6 on the side of a seat facing the user (A side). This produces a uniform contact surface heating.

Expediently at least one heating apparatus 31 has at least one ohmic heating resistor 311. Preferably at least one heating resistor 311 is at least partially arranged on a heating resistor carrier 312, for example, partially or over the full area, for example, by adhesive bonding, by sewing with and without extra threads or by laminating between two flat elements, usually textiles.

The heating resistor 311 is preferably in the form of one or more strands. A “strand” is an object whose extent is much greater in one dimension (for example, 10 times greater) than in its two other dimensions in space. The strand is preferably flexurally elastic, strong and has similar dimensions in two cross-sectional dimensions. It may be a monofilament or a multifilament.

Preferably at least one heating resistor 311 is manufactured partially of metal, for example, as a strand of copper and/or steel wires and/or as a thread with a plastic core and a metal sheathing.

At least one heating resistor 311 is preferably connected to a current source by at least one connecting line 32.

Expediently at least one heating apparatus 31 has at least one heating resistor carrier 312. Preferably at least one heating resistor carrier 312 is at least partially a flat sheeting. Preferably at least one heating resistor carrier 312 is formed at least partially of a textile (for example, knit, woven, nonwoven), polymer foam, flexible thermoplastics, air-permeable material, a plain or embossed film (for example, of polyethylene), the object 2 to be heated and/or at least a portion of its surface or of a covering 6. A suitable material preferably has a thickness of at least 0.5 mm.

The heating resistor cattier 312 is preferably made at least partially of a thermoplastic material. The proportion of this thermoplastic material is preferably between 5% and 100%, especially preferably between 10% and 80%. Polyethylene, polyamide and polypropylene are especially preferred.

The heating resistor carrier 312 is preferably manufactured at least partially from a flame-retardant material.

The base area of the heating resistor carrier 312 has an outer contour which cannot be joined together with congruent areas placed beside it without gaps. The area of the resulting gaps amounts in particular to more than 10% of the base area of the heating resistor carriers 312 involved.

The heating resistor carrier 312 has at least one first carrier segment 3121, which is preferably manufactured from at least one of the materials described as being suitable for the heating resistor carrier 312.

The carrier segment 3121 runs in the plane of the heating resistor carriers 312 but preferably covers its base area only partially.

If the carrier segment 3121 is provided with its own heating resistor 311 and preferably its own connecting lines 32, it may simply be premounted and processed further.

The heating resistor carrier 312 preferably has at least one second carrier segment 3122 and possibly even additional carrier segments. With regard to the choice of materials, the arrangement, size and design, the same thing applies to this accordingly as what was said about the first carrier segment 3121.

If at least one carrier segment 3122 is manufactured at least partially from the same material as another carrier segment 3121, this allows a simple production or a simple physically bonded connection.

If at least one carrier segment 3122 is manufactured at least partially from a material which differs from the material of at least one other carrier segment 3121, then the properties of the heating resistor carrier 312 can be adjusted to locally required conditions in a targeted manner. Preferably at least one carrier segment 3122 differs from at least one other carrier segment 3121 with regard to its color, its air permeability, its thickness, its density and/or its texture. For example, a first carrier segment 3121 may be made at least partially of an air-permeable nonwoven for arrangement on a ventilated surface and at least one additional carrier segment 3122 may consist at least partially of a polymer foam for arranging on a surface that is merely heated.

Preferably at least one additional carrier segment 3122 has at least one heating resistor 311, preferably having its own connecting line 32.

It is also possible to provide for at least one heating resistor 311 to be arranged on the heating resistor carrier 312 so that it covers multiple carrier segments 3121, 3122. In this way larger heating apparatuses can also be manufactured so that they save on materials and are easy to install.

Preferably at least two carrier segments 3122 can be arranged within a rectangular area in such a way that they do not overlap with one another. The rectangular area required for this is preferably smaller than a rectangular area required for complete arrangement of the entire heating resistor carrier 311. This makes it possible to prevent waste of the carrier material.

Preferably at least one carrier segment 3122 is arranged in such a way that it preferably covers a portion of the base area of the heating resistor carrier 312 which is left exposed by at least one additional carrier segment 3121, i.e., is not covered. This portion of the base area is preferably left exposed by all other carrier segments 3121.

The carrier segment 3122 preferably extends exclusively in this portion of the base area. Preferably at least one carrier segment 3121 is arranged so that it is flush with at least one additional carrier segment 3122. This is understood to mean that the carrier segments 3121, 3122 run at least partially in the same plane, face one another with at least one of their lateral faces (“end faces”) and/or overlap slightly (for example, max. 10 mm, better yet max. 5 mm, even better 0.1 mm).

Preferably at least one carrier segment 3121 has at least one heating resistor 311a, which differs in its material composition, its dimensions and/or its electric resistance from at least one heating resistor 311b arranged on another carrier segment 3122. For example, a heating resistor 311a on a first carrier segment 3121 may be made at least partially of a carbonaceous material, a PTC printing paste and/or a conductive plastic or a plastic with a conductive coating. Second heating resistor 311b may be formed at least partially from a strand containing metal or from another material not used for the first resistor.

At least the heating resistor carrier 312 has at least one connecting zone 3123 on which at least two carrier segments 3121, 3122 are joined together. This connection is preferably embodied as a physically bonded connection, for example, by adhesive bonding (for example, when at least one component made of foam is involved) or by welding (for example, when using thermoplastically processable material, in particular textiles or film). However, fastening by means of adhesive tape and lamination may also be considered.

Sewing is also possible but tends to be of lesser significance because of the necessary overlap and thickening of the heating resistor carrier 312 at the connecting zone 3123.

A connecting zone 3123 preferably extends essentially linearly along the butt edge of the carrier segments 3121, 3122 involved. The connecting zone 3123 preferably has a width of max. 15 mm, preferably max. 10 mm, especially preferably 5 mm, most preferably 1 mm or less.

The connecting zone 3123 has a tensile strength across its machine direction which is preferably at least as high as the tensile strength of at least one of the carrier segments 3121, 3122, preferably higher, especially preferably higher than that of the two carrier segments 3121, 3122. This can be achieved, for example, with linear ultrasonic welding of two carrier segments made of a thermoplastically processable nonwoven.

Expediently two carrier segments 3121, 3122 in the connecting zone are arranged so they overlap slightly with one another. Then they are partially melted using an ultrasonic welder in such a way that the overlapping region is at least partially softened or liquefied. Simultaneously or immediately thereafter, the molten regions are pressed together, so that it no longer has the thickness of two layers stacked one above the other but instead again has the same thickness as the other regions of the carrier segments 3121, 3122.

It may be expedient to arrange multiple welds side by side and preferably in the same direction of flow. Their spacing from one another is preferably only a few millimeters (approx. 0.5-10 mm). The welding may also be at least partially not linear but rather spot welding. It may also be expedient to combine several joining methods, for example, welding and knurling, adhesive bonding and welding or sewing and lamination.

### LIST OF REFERENCE NUMERALS

1 vehicle
2 heated object
5 cushion
6 covering
30 thermal regulation unit
31 heating apparatus
32 connecting line
311, A, B heating resistor
312 heating resistor carrier
3121, 3122 carrier segment
3123 connecting zone

1. An electric heating apparatus comprising at least one electric heating resistor and at least one flat heating resistor carrier, characterized in that the heating resistor carrier consists of at least two carrier segments.

2. The electric heating apparatus according to claim 1, characterized in that at least two carrier segments are designed to be flat and are arranged so they are flush with one another in at least one connecting zone.

3. The electric heating apparatus according to claim 1, characterized in that the at least one first carrier segment and the at least one second carrier segment are joined to one another in at least one segment by at least one ultrasonic welding.

4. The electric heating apparatus according to claim 1, wherein the electric heating apparatus is disposed in an interior object of a vehicle.

5. The electric heating apparatus according to claim 1, characterized in that the at least two carrier segments of a heating resistor carrier are attached to one another so that they are aligned.
